(19) United States
(12) Patent Application Publication
(10) Pub. No.: US 2014/0123972 A1
(43) Pub. Date: May 8, 2014

(54) HIGH EFFICIENCY WOOD-BURNING GRIDDLE COOK STOVE

(71) Applicant: ENVIROFIT INTERNATIONAL, LTD., Fort Collins, CO (US)

(72) Inventors: Jason A. Prapas, Fort Collins, CO (US); Jesse Walker, Fort Collins, CO (US); Nathan Lorenz, Laporte, CO (US); Sean Babbs, Fort Collins, CO (US); Timothy Bauer, Fort Collins, CO (US)

(73) Assignee: ENVIROFIT INTERNATIONAL, LTD., Fort Collins, CO (US)

(21) Appl. No.: 14/073,413

(22) Filed: Nov. 6, 2013

Related U.S. Application Data
(60) Provisional application No. 61/723,179, filed on Nov. 6, 2012.

(51) Int. Cl. F24B 1/00; A47J 37/06; F24B 7/00

(52) U.S. Cl. CPC F24B 1/003; F24B 7/002; A47J 37/067
USPC 126/77; 99/422

(57) ABSTRACT

Disclosed herein are devices and methods that aid in providing high efficiency stoves for developing and underdeveloped regions. In some embodiments, the stoves are plancha-style stoves comprise cast iron planchas that are more durable and efficient that existing stoves. The plancha-style stoves, described herein may comprise a combustion chamber comprising an inlet, a stack chamber comprising an inlet and an outlet; a gas path chamber, comprising a ceiling and a floor, wherein the ceiling is defined by a removable plancha cooking surface having a substantially planar upper surface and a lower surface; a chimney box; and a chimney. In many embodiments, the stack chamber defines a cross-sectional area that is larger than the cross-sectional area of the inlet to the combustion chamber to prevent smoke from escaping the combustion chamber through the inlet.

### CROSS REFERENCE TO RELATED APPLICATIONS

This application claims benefit of priority pursuant to 35 U.S.C. §119(e) of U.S. provisional patent application No. 61/723,179 filed Nov. 6, 2012, which is hereby incorporated herein by reference in its entirety.

### FIELD

The disclosed processes, methods, and systems are directed to griddle cook stoves.

### BACKGROUND

Plancha-style stoves are a widely popular stove style in some parts of the world, for example regions of Honduras, Guatemala, Nicaragua, Panama, and Mexico, but may be found in many other countries and regions. These stoves consist of a griddle surface that is heated from below. The griddle surface provides heat for cooking foods such as tortillas, and for heating flat bottomed cooking vessels.

Existing plancha-style stoves generally lack durability and often suffer from cracking, corrosion, or warping of the cooking surface. This leads to low performance as well as limited lifetimes for the plancha surface. Low performance also results from the failure of existing designs to provide a cook surface with uniform temperature distributions. Often, one part of the plancha surface is very hot while the remainder is much less hot. This uneven distribution creates a non-uniform surface, which can result in increasing the time and effort/involvement needed to prepare food. This inefficiency also results in higher fuel use.

What is needed is a low-cost plancha-style stove that is efficient, durable, and provides a more uniform distribution of heat over the surface of the plancha.

### SUMMARY

Provided herein are plancha style stoves, planchas for use in plancha-style stoves, and methods of using and creating the same. In many embodiments, the disclosed stove may comprise a combustion chamber comprising an inlet, a stack chamber comprising an inlet and an outlet; a gas path chamber, comprising a ceiling and a floor, wherein the ceiling is defined by a removable plancha cooking surface having a substantially planar upper surface and a lower surface; a chimney box; and a chimney. In one embodiment, the stack chamber defines a cross-sectional area that is larger than the cross-sectional area of the inlet to the combustion chamber, the stack chamber is wider at or near the outlet than near the inlet, the cross-sectional area of the stack chamber varies less than 10% between the inlet and the outlet, or is the same at the inlet as at the outlet. In another embodiment of the disclosed stove, the floor of the gas path chamber is separated by a greater distance from the ceiling at the or near the gas path chamber inlet as compared to the gas path chamber outlet.

Also disclosed herein are planchas for use in plancha style stoves, wherein the plancha lower surface comprises a plurality of fins extending from the lower surface, for example wherein the fins extend from at or near a rear end toward the front end, or wherein the fins define a straight line running from at or near the rear end to the front end. In some embodiments, the fins define a height measured from the lower surface to the tip of the fin, and wherein one or more of the fins has a height that varies from the rear end of the plancha to the front end. In many embodiments, the plancha comprises an alloy material selected from iron, steel, or aluminum, for example cast iron, milled steel, or aluminum. In some embodiments, the disclosed plancha defines a thickness between the upper surface and the lower surface, and wherein the thickness of the plancha is smaller at the rear end as compared to the front end.

While multiple embodiments are disclosed, still other embodiments of the present invention will become apparent to those skilled in the art from the following detailed description. As will be apparent, the invention is capable of modifications in various obvious aspects, all without departing from the spirit and scope of the present invention. Accordingly, the detailed description is to be regarded as illustrative in nature and not restrictive.

### BRIEF DESCRIPTION OF THE DRAWINGS

FIG. 1 Depicts a cooking apparatus comprising the presently claimed plancha-style stove.

FIG. 2 Is a side cross-sectional view of one embodiment of the disclosed plancha style stove.

FIG. 3 Is a front perspective view of the combustion chamber and stack of one embodiment of the disclosed plancha style stove.

FIG. 4 Is a front perspective cross-sectional view of one embodiment of the disclosed plancha style stove.

FIG. 5A Is a top perspective view of one embodiment of a plancha of one embodiment of the disclosed plancha style stove.

FIG. 5B Is a bottom perspective view of the plancha of FIG. 5A.

FIG. 6A Is a cross-sectional view of the plancha of FIG. 5A.

FIG. 6B Is a cross-sectional view of the plancha of FIG. 5A.

FIG. 7A-H Plancha surface thermographs of embodiments of the disclosed plancha-style stove and an existing plancha design, a Justa-design. FIG. 7A is a Justa plancha. FIGS. 7B-H depict different embodiments of the disclosed plancha; 7B, V1.0, combustion chamber widened and placement adjusted; 7C, V1.1, tapered depth of gas path chamber; 7D, V1.2, centralized restriction added to rear portion of gas path chamber; 7E, V1.3, insulation added to combustion chamber; 7F, V1.4, insulation added to gas path and deflector added and rear widened; 7G, V1.5, support ribs added to gas path chamber; 7H, V1.6.

FIG. 8 Depict bar charts comparing the efficiency of the Justa design and one embodiment of the presently disclosed plancha.

FIG. 9A-B Plancha surface thermographs comparing one embodiment of the disclosed plancha-style stove (FIG. 9B) and a Justa plancha design (FIG. 9A).

### DETAILED DESCRIPTION

Described herein are embodiments of high performance stoves, for example plancha-style stoves. In many cases, the disclosed stove may be used in undeveloped, or underdeveloped areas or countries. In one example, the disclosed stove may be for use in Central and South America.

The disclosed methods and devices aid in providing plancha-style stoves that are durable and may demonstrate improved performance. The disclosed planch-style stoves may provide for improved durability, performance, and fuel efficiency. In some cases, the disclosed plancha may provide several years of life without major structural issues, for example warping, cracking, and/or corroding of the stove or plancha surface. In many cases, the disclosed plancha surface may include stiffening elements that aid in preventing deformation of the cooking surface that may be due to exposure to high temperatures. In many cases, the disclosed plancha-style stove may be designed to provide a more uniform cooking surface of the plancha.

### Plancha-Style Stove

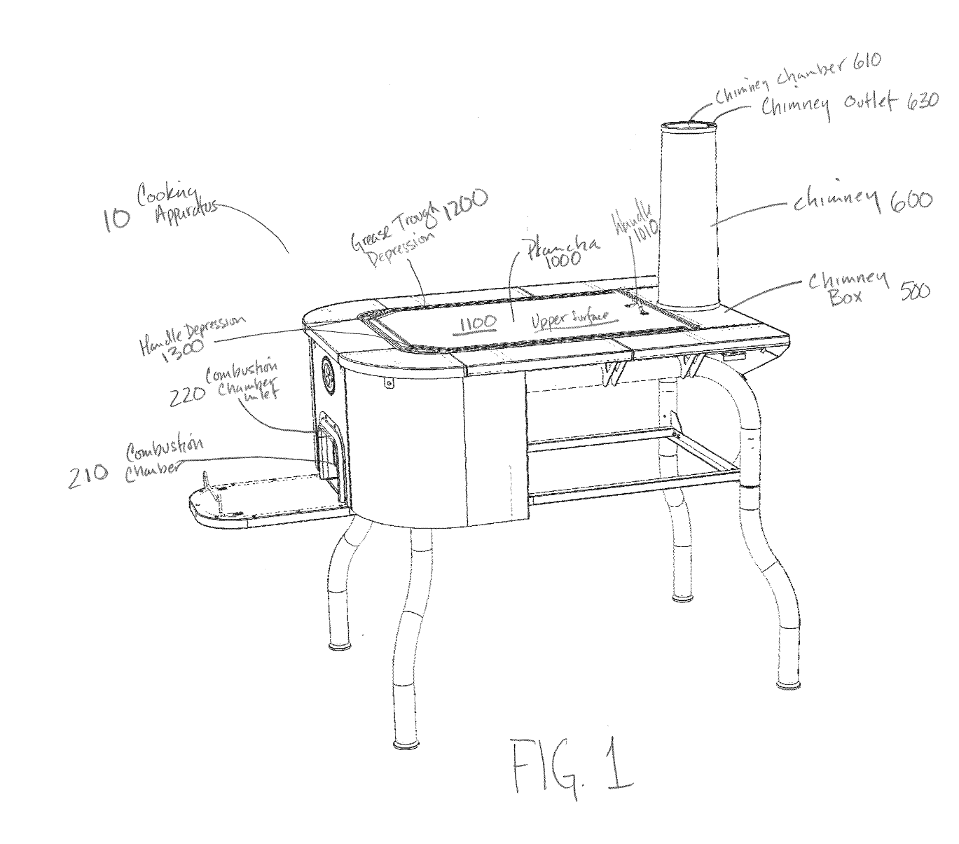

The disclosed plancha-style stove may include a combustion box (defining a combustion chamber), a stack (defining a stack chamber), a gas path (defining a gas path chamber), a cooking surface (plancha), a chimney box (defining a chimney box chamber), and a chimney (defining a chimney chamber). Several of these structures are visible in the cooking apparatus 10 depicted in FIG. 1, such as the combustions chamber 210, the plancha 1000, the chimney box 500, and the chimney 600. In many cases the components of the plancha-style stove may be designed to improve the stove's durability, performance, and efficiency compared to other, existing stoves.

The disclosed plancha-style stove may accomplish cooking tasks similar to existing stoves, but do so more efficiently. In many cases, increased efficiency is demonstrated by faster cooking time, lower emissions, more uniform cooking surface, less fuel consumption, or a combination thereof. In many cases, the disclosed stove may require less fuel than existing stoves to perform similar tasks. In many cases, increased fuel efficiency may be, in part, due to the plancha-style stove having a reduced thermal mass. In many cases, reduction of thermal mass in combination with improved heat transfer, and sizing of various stove components (combustion chamber, gas path, chimney) for appropriate firepower, may aid in achieving lowered fuel usage as compared to existing stove designs.

The presently disclosed plancha-style stove may be more efficient than existing stove. In some embodiments, the disclosed plancha stove uses less fuel than existing styles in a water boiling test, for example less than about 90%, 85%, 80%, 75%, 70%, 65%, 60%, 55%, 50%, or 45% and/or greater than 40%, 45%, 50%, 55%, 60%, 65%, 70%, 75%, 80%, or 85%. In some embodiments, the disclosed plancha stove may boil water faster than existing styles using a water boiling test, for example less than about 95%, 90%, 85%, 80%, 75%, 70% or 65% of the time required by the existing plancha stove and/or greater than 60%, 65%, 70%, 75%, 80%, 85%, or 90% of the time required by the existing planch design.

In many embodiments, the disclosed plancha-style stove may be at least partially insulated. In some cases, insulation may aid in reducing the loss of heat and/or lower the production of emissions. Insulation may be provided by various materials, for example natural and synthetic materials. In some cases, insulation may be glass or ceramic, for example fiberglass or fiberfrax insulation.

### The Combustion Chamber

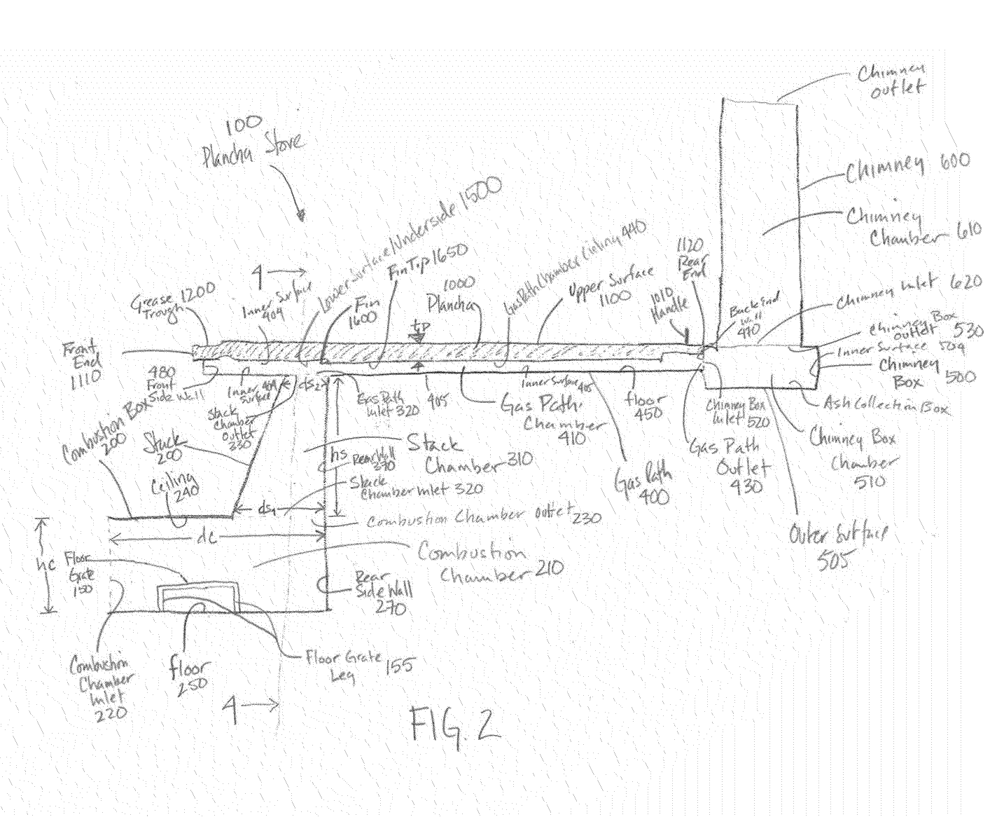

With reference to FIG. 1 and FIG. 2, the combustion box 200 may define an inner surface 204 and an outer surface 205, and may further define an inlet 220 and an outlet 230. The interior surface 204 of the combustion box 200 may further define a combustion chamber 210 comprising side walls 260, a front wall 280, a back wall 270, a floor 250 and a ceiling 240. The interior surface 204 may be in fluid communication with a fuel (not shown) placed within the combustion chamber 210. In some cases, the combustion chamber may be designed to hold a fuel source, for example wood, coal, charcoal, or other natural or synthetic fuels. The combustion chamber 210 may also allow for air to mix with the fuel. In many cases, the combustion chamber 210 may define an inlet 220 designed to allow outside/ambient air to enter the combustion chamber 210, mix with and aid in combusting the fuel, and an outlet 230 designed to allow air and hot combustion gasses to exit the combustion chamber 210. In many cases the fuel may be held by a grate 150 designed to allow air to mix with the fuel.

The combustion chamber 210 may define a height (hc), a width (wc), and a depth (dc). The combustion chamber 210 may take any shape. In some cases, the combustion chamber may be square shaped, with four walls, a ceiling, and a floor. In some cases, one or more walls 260, 270, 280 of the combustion chamber may define the combustion chamber inlet 220. In many cases, the height of the combustion chamber, hc, may vary, but in general the height may be the distance between the ceiling 240 and the floor 250 (in some cases the floor comprises a brick). The width of the combustion chamber, wc, may also vary, but represents the distance between the walls 260 on either side of the inlet 220. The depth may represent the distance from the inlet 220 to a back wall(s) 270.

The ceiling 240, walls 260, 270, 280 and floor 250 of the combustion chamber 210 may be made, partially or completely, of a metal, for example a metal alloy. In some cases the interior surfaces 204 of the combustion chamber 210 may be clad with a metal alloy that may resist corrosion by gases at high temperatures. In some cases, the alloy may aid in preventing corrosion and/or increase the useful life of the stove. In some case, the combustion chamber may comprise stainless steel, or a metal alloy comprising iron, chromium, and aluminum.

The combustion chamber may be designed to reduce thermal warping, for example by placing relief features on the metal or alloy. In some cases the relief structures may be placed on the metal by stamping. The relief structures may raise either the surface of the interior or exterior surface of the combustion chamber.

The floor 250 of the combustion chamber 210 may be stone, or may be covered by stone, brick, tile, or other material. In some cases, refractory bricks may be used. In some cases, stone, brick, tile or other materials may be at the bottom and/or the sides of the combustion chamber. In these cases, the height of the combustion chamber is measured from the ceiling to the brick or tile surface.

The combustion chamber may be designed to minimize loss of heat. In some cases, heat loss may be reduced by insulating the combustion box. In some cases, an insulating material may surround the combustion box and/or be in contact with the outer surface 205. In other embodiments, the insulation may be placed within the combustion chamber 210 and be in contact with the inner surface 204. In still further embodiments, the insulation may be placed within the combustion chamber 210 and outside the combustion box 200. Insulation material may be natural or synthetic insulation. In some cases, the insulating material is adobe, cement, clay, mud, brick, or tile. In many cases, insulation may aid in enhancing heat produced by combustion of the fuel and/or may aid in reducing the production of emissions from the stove. In some cases, refractory tile may aid in preventing or reducing heat loss from the bottom of the combustion chamber.

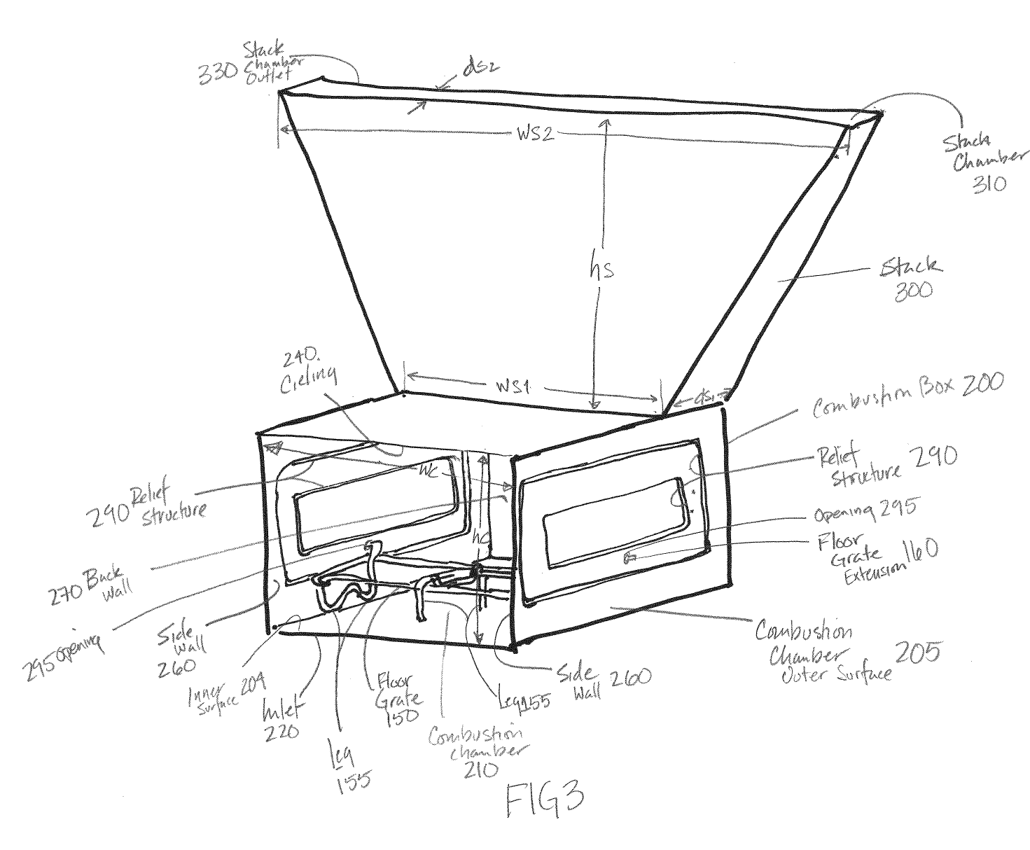

A fuel grate 150 may be positioned within the combustion chamber. As depicted in FIGS. 2 and 3, the fuel grate 150 may include a plurality of leg structures 150 designed to rest upon the combustion chamber floor 250. The fuel grate 150 may be designed for allowing access to the floor of the combustion chamber, for example by being fully or partially removable. In some cases, the fuel grate 150 may include extensions 160 designed to engage one or more holes/openings 295 in one or more sides 260 of the combustion chamber. In some cases, a fuel grate 150 with extensions 160 may be designed to be swung in an upward motion while pivoting on the extensions 160 engaged with the sides 260 of the combustion chamber 210. These structures are visible in FIG. 3. The fuel grate may aid in holding the fuel. In some cases, the fuel grate may aid in allowing air to be delivered to the fuel during combustions. In many cases, the grate may aid in allowing air to enter the fuel from at or near the floor.

The combustion chamber inlet 220 may be designed to minimize escape of combustion gases/smoke from the combustion chamber 210. This may aid in the use of the plancha-style stove 100 in confined spaces, such as within a covered structure, room, kitchen, or home. In cases where the inlet 220 defines a square or rectangle, the combustion chamber inlet 220 may define a cross-sectional area that may be equal to the height of the combustion chamber at the inlet multiplied by the width of the combustion chamber at the inlet. The combustion chamber inlet may be any shape, and the cross-sectional area may be defined by the area of that shape. In many cases, the cross-sectional area of the inlet may be less than the cross-sectional area of another position of the combustion chamber, for example the combustion chamber outlet. In various embodiments, the cross-sectional area of the combustion chamber inlet may be less than cross-sectional area of the outlet by less than about 15%, 14%, 13%, 12%, 11%, 10%, 9%, 8%, 7%, 6%, 5%, 4%, 3%, 2% or 1%, and/or greater that about 0.1%, 1%, 2%, 3%, 4%, 5%, 6%, 7%, 8%, 9%, 10%, 11%, 12%, 13%, or 14%.

In many cases, the combustion chamber inlet may be designed to allow fuel to be added to the combustion chamber. In some cases, the combustion chamber inlet may be partially or fully covered by a door or other structure designed to fully or partially reduce the cross-sectional area of the combustion chamber inlet.

The combustion chamber outlet 230 is in fluid communication with the combustion chamber 210 and the combustion chamber inlet 220. In many cases, the combustion chamber ceiling 240 may define the combustion chamber outlet 230. In other case the combustion chamber outlet 230 is defined by a combustion chamber wall 260, 270, 280 for example a wall(s) 260 positioned opposite the combustion chamber inlet 220. In other cases, the ceiling and walls define the combustion chamber outlet. In cases where the outlet defines a square or rectangle, the combustion chamber outlet may define a cross-sectional area that may be equal to the width of the combustion chamber at the outlet multiplied by the a fraction of the depth of the combustion chamber. FIG. 3 depicts the depth, ds1, of the combustion chamber outlet 230. The combustion chamber inlet 220 may be any shape, and the cross-sectional area may be defined by the area of that shape. In many cases, the cross-sectional area of the combustion chamber outlet 230 may be larger than the cross sectional area of the combustion chamber inlet 220, which may aid in reducing the amount of combustion gases that escape from the combustion chamber inlet 220, and/or may aid in drawing air into the combustion chamber inlet 220 and through the plancha stove 100.

The combustion chamber outlet may be any shape. In many cases, the combustion chamber outlet may allow for exit of air and combustion gasses from the combustion chamber, and may further aid in directing combustion gasses toward or into a combustion stack chamber 310.

### Combustion Stack Chamber

As depicted in FIGS. 2-4, the stack 300 is positioned between the combustion box 200 and the gas path 400. Thus, the combustion stack chamber 310 is positioned above the combustion chamber 210, and below the gas path chamber 410. The stack chamber 410 is in fluid communication with the combustion chamber 210. In most cases, the stack chamber 310 aids in directing combustion gasses from the combustion chamber 210 to the gas path chamber 410. The combustion stack chamber 310 may define an inlet 320 and an outlet 330. In most cases, the combustion stack chamber inlet is designed to fixedly attach to the outlet of the combustion chamber.

The stack chamber 310 may define a width, ws, a height (or length), hs, and a depth, ds. The height of the stack chamber 310 may be the distance from the inlet 320 to the outlet 330. In many cases the width, ws, of the stack chamber 310 may vary between the inlet 320 (ws1) and the outlet 330 (ws2). In many cases, the width of the stack chamber 310 is greater near the outlet 330 than near the inlet 320. In many cases the depth, ds, of the stack chamber may vary between the inlet 320 (ds1) and the outlet 330 (ds2). In many cases, the depth of the stack chamber 310 is greater near the inlet 320 than near the outlet 330.

The stack chamber inlet 320 may define a cross-sectional area. In cases where the cross-section of the stack chamber defines a rectangle, the cross-sectional area may be the width multiplied by the depth. In many cases, the cross-sectional area of the combustion stack is constant throughout the height, or length of the combustion stack. In many cases, the cross-sectional area of the combustion stack varies between the inlet and the outlet less than about 10%, 9%, 8%, 7%, 6%, 5%, 4%, 3%, 2%, or % 1 and more than about 1%, 2%, 3%, 4%, 5%, 6%, 7%, 8%, or 9%. The combustion stack cross-section may define various shapes.

In many cases, the combustion stack 300 may be fixedly attached to the combustion box 200 and the gas path 400, for example by welds, rivets, tabs, etc.

### Plancha

The disclosed plancha-style stove 100 aids in the transfer of heat from a combustion gas to the plancha 1000. The plancha may be positioned above the gas path chamber 410, and may define a ceiling 440 of the gas path chamber 410.

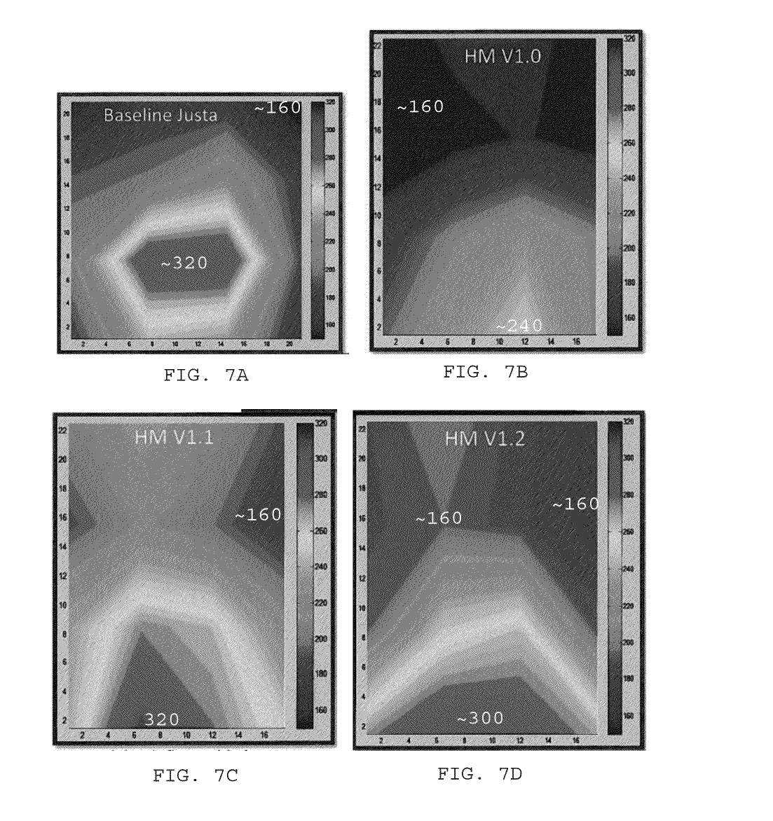

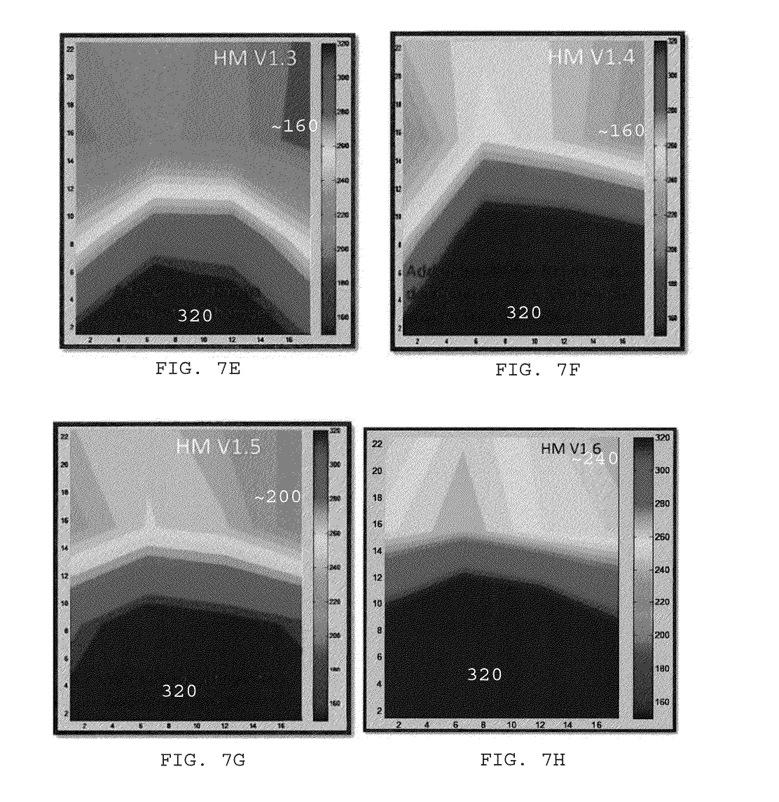

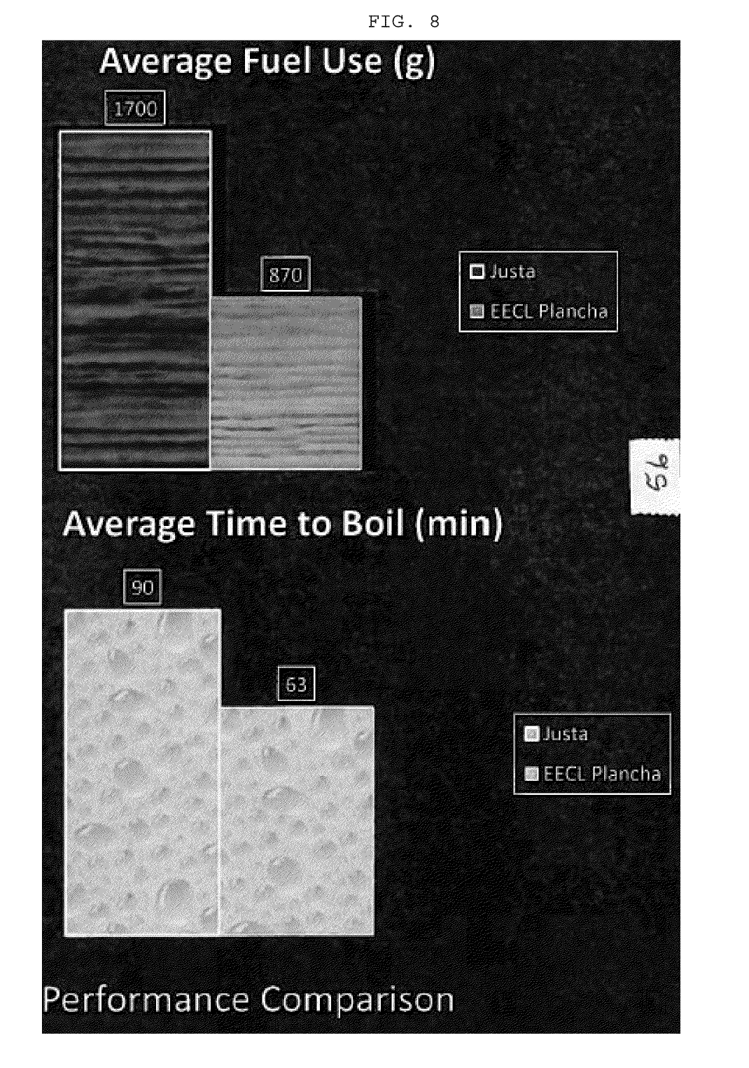

With further reference to FIGS. 6A, 6B, 7A, and 7B, the plancha 1000 may further define an upper surface 1100 and a lower surface 1500, and a front end 1110 and a rear end 1120. The lower surface 1500 of the plancha 1000 may be in fluid communication with the stack chamber 310 and combustion chamber 210. The lower surface 1500 of the plancha may be designed to transfer heat from the combustion gases to the upper surface 1100 of the plancha 1000. The presently disclosed plancha 1000 may provide for a more uniform temperature across the plancha upper surface 1100 than existing plancha designs.

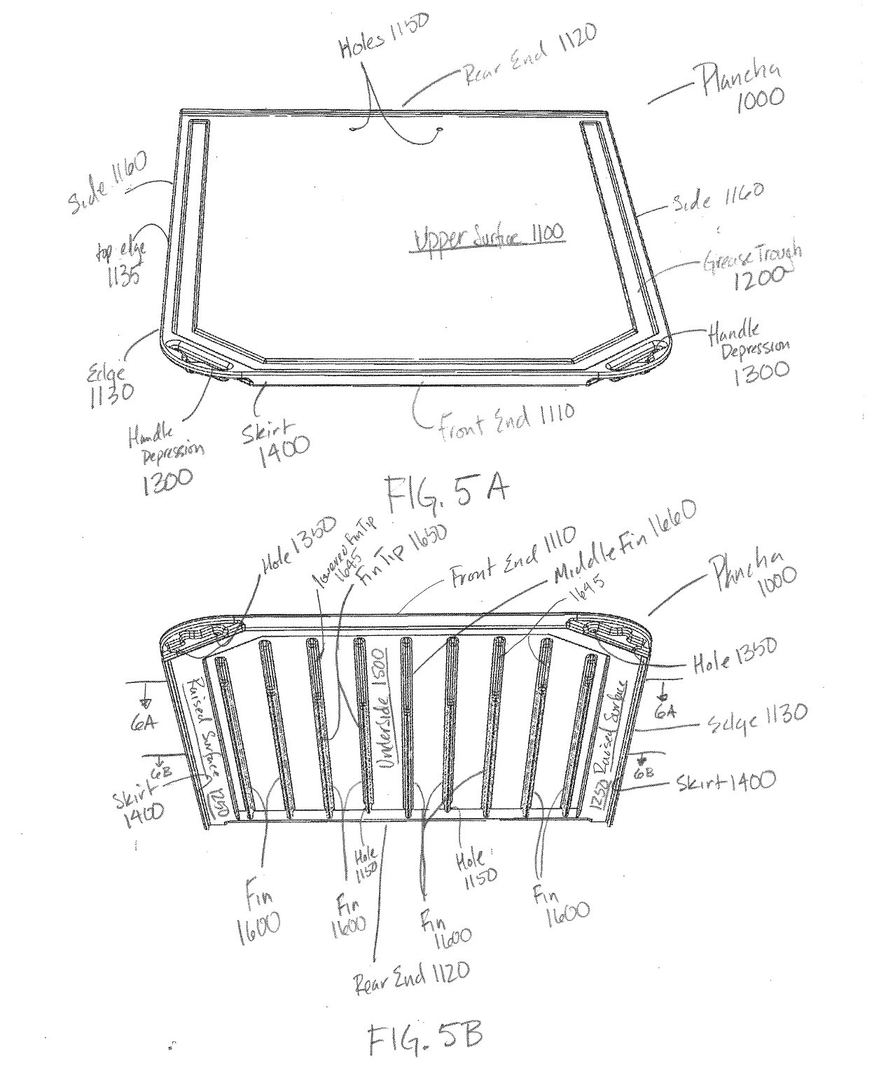

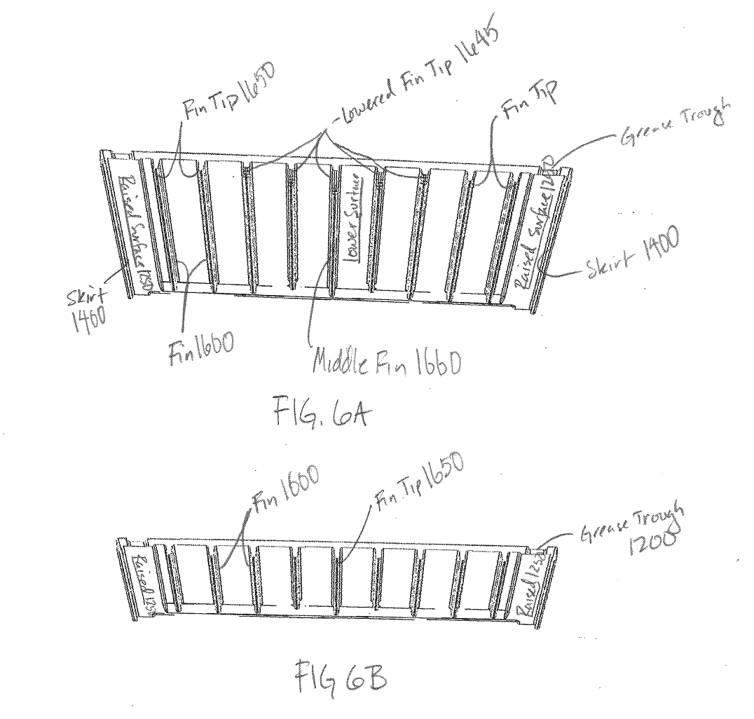

The lower surface 1500 of the plancha 1000, or underside, shown in detail in FIGS. 5B-7B, may be designed to aid in the transfer and distribution of heat to the upper surface 1100. In many cases, fins 1600 and/or contours may be formed in the underside 1500 of the plancha. In many cases, the fins 1600 aid in promoting uniform heating of the plancha surface 1100 and/or the fins may aid in stabilizing the plancha 1000 and inhibiting warping. The fins may define a height measured from the lower surface 1500 of the plancha to a fin tip 1650. In some embodiments, the fin may comprise a uniform height along the length of the fin. In other embodiments, the fin's height may vary. In some cases, the fin height may be greater near the rear end 1120 of the plancha and lesser at the front end 1110 of the plancha 1000, that is the height of the fin tip 1650 may higher than a lowered fin tip 1645. In some cases, the fins may aid in reinforcing the plancha, reducing thermal warping, and/or enhancing the useable life of the plancha. In some embodiments, the height of the fin may be greater than about 0.15 in., 0.16 in., 0.17 in., 0.18 in., 0.19 in., 0.20 in., 0.21 in., 0.22 in., 0.23 in., 0.24 in., 0.25 in., 0.26 in., 0.27 in., 0.28 in., 0.29 in., 0.30 in., 0.31 in., 0.32 in., 0.33 in., 0.34 in., 0.35 in., or 0.36 in. and less than about 0.37 in., 0.36 in., 0.35 in., 0.34 in., 0.33 in., 0.32 in., 0.31 in., 0.30 in., 0.29 in., 0.28 in., 0.27 in., 0.26 in., 0.25 in., 0.24 in., 0.23 in., 0.22 in., 0.21 in., 0.20 in., 0.19 in., 0.18 in., 0.17 in., or 0.16 in. In some cases, the lowered fin tip 1645 height may be greater than about 0.5 in., 0.06 in., 0.07 in., 0.08 in., 0.09 in., 0.10 in., 0.11 in., 0.12 in., 0.13 in., 0.14 in., 0.15 in., 0.16 in., 0.17 in., 0.18 in., 0.19 in., 0.20 in., 0.21 in., 0.22 in., 0.23 in., 0.24 in., 0.25 in., 0.26 in., 0.27 in., 0.28 in., or 0.29 in. and less than about 3.0 in., 0.29 in., 0.28 in., 0.0.27 in., 0.26 in., 0.25 in., 0.24 in., 0.23 in., 0.22 in., 0.21 in., 0.20 in., 0.19 in., 0.18 in., 0.17 in., 0.16 in., 0.15 in., 0.14 in., 0.13 in., 0.12 in., 0.11 in., 0.10 in., 0.09 in., 0.08 in., 0.07 in., or 0.06 in.

In some cases, the underside 1500 of the plancha may define between about 1 and 20 fins. In some cases, the underside of the plancha may define more than about 1, 2, 3, 4, 5, 6, 7, 8, 9, 10, 11, 12, 13, 14, 15, 16, 17, 18, or 19 fins and less than about 20, 19, 18, 17, 16, 15, 14, 13, 12, 11, 10, 9, 8, 7, 6, 5, 4, 3, or 2 fins. In some embodiments, the underside of the plancha may define 9 fins, wherein the fins define different heights along the length of the plancha.

The front end of the plancha is proximal the combustion chamber inlet, and the rear end of the plancha is proximal the chimney. In many cases, the one or more fins of a plancha may be uniform height and other fins may have a variable height.

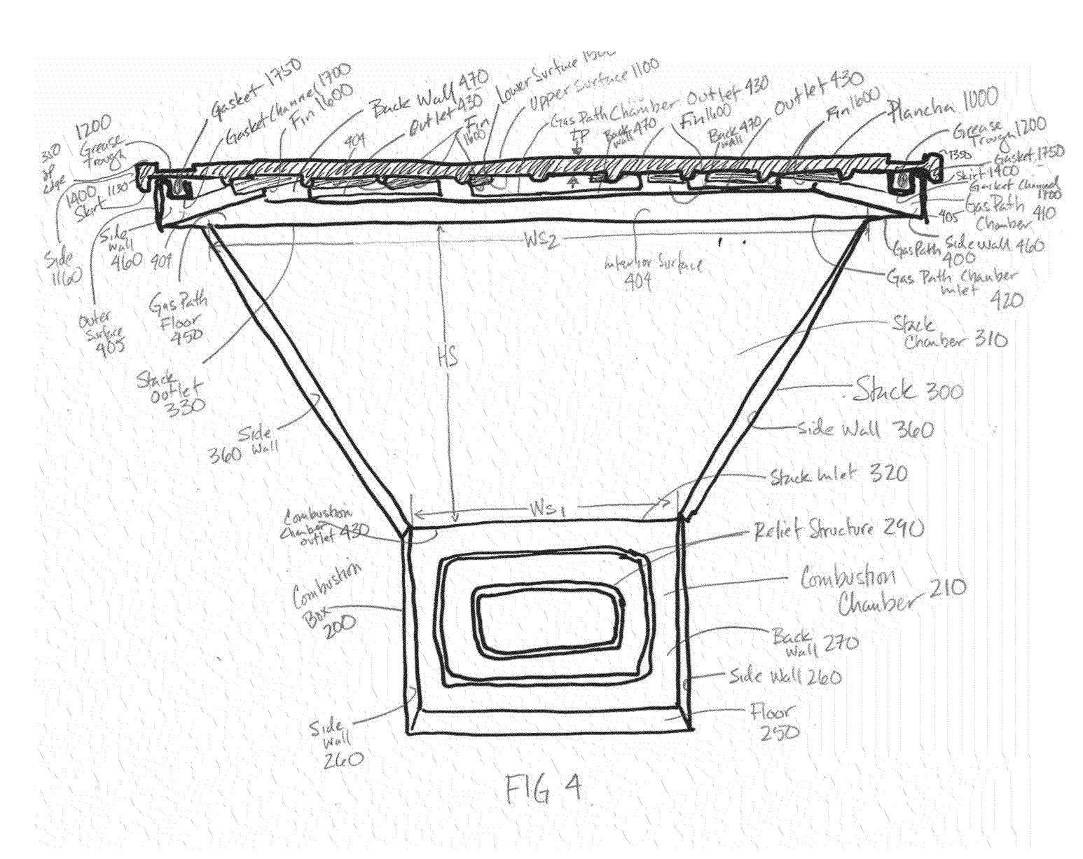

As seen in FIGS. 2 and 4, the plancha may define a thickness, tp, measured from the upper surface 1100 of the plancha to the underside 1500 of the plancha. In many cases, the thickness, tp, of the plancha may vary from the front end 1110 to the rear end 1120, positioned near the chimney 600. In some cases, variations in plancha thickness may aid in heat distribution and/or may alter the plancha's response to heat. In many cases, the thickness of the plancha is greater at or near the front end of the plancha and lesser at the rear end of the plancha. The thickness of the plancha may be less than about 0.40.0 in., 0.39 in., 0.38 in., 0.37 in., 0.36 in., 0.35 in., 0.34 in., 0.33 in., 0.32 in., 0.31 in., 0.30 in., 0.29 in., 0.28 in., 0.27 in., 0.26 in., 0.25 in., 0.24 in., 0.23 in., 0.22 in., 0.21 in., 0.20 in., 0.19 in., 0.18 in., 0.17 in., 0.16 in., or 0.15 in. and greater than about 0.14 in., 0.15 in., 0.16 in., 0.17 in., 0.18 in., 0.19 in., 0.20 in., 0.21 in., 0.22 in., 0.23 in., 0.24 in., 0.25 in., 0.26 in., 0.27 in., 0.28 in., 0.29 in., 0.30 in., 0.31 in., 0.32 in., 0.33 in., 0.34 in., 0.35 in., 0.36 in., 0.37 in., 0.38 in., or 0.39 in. In one embodiment, the thickness of the plancha may vary between about 0.20 and 0.325 in., or between about 0.16 and 0.24 in.

The upper surface of the plancha is generally planar. In some embodiments, the upper surface of the plancha is flat. In other embodiments the planar surface may be sloped downward from a midline to an edge of a depression or the edge of the plancha. In most embodiments, the slope may be less than 5°, 4°, 3°, 2°, or 1° and/or greater than about 0.1°, 1.0°, 2.0°, 3.0°, or 4.0°. In many cases, the degree of slope is less than about 3.0°, 2.8°, 2.6°, 2.4°, 2.2°, 2.0°, 1.8°, 1.6°, 1.4°, 1.2°, 1.0°, 0.8°, 0.6°, 0.4°, or 0.2°.

The upper surface of the plancha may include a variety of structures. In some embodiments the upper plancha surface 1100 may define an edge 1130 that may define an outer limit of the plancha 1000. In some embodiments, the upper surface 1100 of the plancha may define a depression 1200 near the edge 1130 that may be lower than the upper surface 1100 of the plancha and a top edge 1350 of the plancha 1000. In some embodiments, the depression 1200 may define a raised surface 1250 at the lower surface of the plancha. In some embodiments, the raised surface 1250 may extend to at or near the plancha edge 1130. In some embodiments a skirt 1400 may extend downward from the raised surface 1250. The depression 1200 may be designed to aid in removing waste material, for example grease, from the upper surface of the plancha. In many cases, the depression, defining a depth and a width, may be defined in the front end and sides of the plancha but not the rear end of the plancha. This depression may be referred to as the grease trough.

The upper surface of the plancha may further define a plurality of holes 1150 and/or recesses. In some embodiments, holes 1150 in the plancha surface may extend through the thickness of the plancha to create a channel through the plancha. In some embodiments, holes 1150 defined in the plancha may aid in positioning structures, for example a handle 1010, that allow the plancha 1000 to be lifted and/or repositioned on the stove 100.

In some embodiments a hole 1150 positioned at or near the rear end of the plancha may receive a handle 1010 structure configured for lifting the plancha 1000. In some embodiments the plancha may include one or more holes 1350 positioned at or near the front end 1110 of the plancha 1000 at or near one or both sides 1160, wherein the holes 1350 are configured to accept a handle structure, that may be similar to the handle 1010 at the rear end, and which may be used to lift or reposition the plancha 1000. In many cases handle structures may be fixedly attached to the plancha, and the upper surface of the plancha may define a recess 1300 configured to receive the handle structure and support the handle structure at or below the upper surface 1100 of the plancha 1000. In FIGS. 5A and 5B, these depressions are positioned near the front of the plancha proximal the sides.

In further embodiments, holes in the plancha may allow the positioning of a cooking pot/vessel on or in the plancha. In some cases, a bottom surface of the vessel or pot may extend through the hole and may contact the heated gases within the gas path chamber. In other cases, the surface of the plancha may include one or more depressions configured to accept a cooking vessel.

The plancha may be designed to be supported by one or more walls 460 470 of the gas path chamber 410. In many cases, the plancha may rest upon a gasket 1750 positioned on the wall 460 of the gas path chamber 410. The gasket 1750 may aid in preventing escape of combustion gases from the sides 460 or front of the gas path chamber 410. The gasket may be comprised of any material that may withstand high temperatures, for example fiberglass. In some cases, the gasket may be fiberglass gasket rope.

The plancha may define a skirt 1400 at or near the edge 1130 of the plancha 1000. The skirt 1400 may extend downward from the lower surface/under side 1500 or the raised surface 1250 of the plancha 1000. In many embodiments, the skirt 1400 may aid in creating a fluid seal around the edges 1130 and side walls 460 of the plancha 1000 and prevent or reduce combustion gases exiting the gas path chamber 420 other than through the outlet 430.

In some cases, the plancha may be hinged to aid in accessing the gas path below the plancha. In some embodiments, the hinge or hinges may be positioned at the back 1120 of the plancha, near the chimney 600. In other embodiments, the hinge may be positioned near the front 1110 or sides 1160 of the plancha 1000.

### Gas Path Chamber

The gas path 400 may define an outer surface 405, and an interior surface 404, defining a gas path chamber 410 comprising a ceiling 440, a floor 450, a front end wall 480, a back end 470, and sides 460 (or walls). The gas path chamber 410 inner surface 404 is in fluid communication with the combustion gases within the stove 100. The gas path chamber 410 defines a height that is the distance from the floor 450 of the chamber to the ceiling 440, or underside 1500 of the plancha 1000. The gas path chamber 410 may define a cross-sectional area. In many cases, such as wherein the cross-section is rectangular, the cross-sectional area may be equivalent to the distance measured between the walls of the gas path chamber, and the height of the gas path chamber at that position.

The front end wall 480 of the gas path chamber 410 is proximal the front end 1110 of the plancha 1000, and the back end wall 470 of the gas path chamber 410 may be proximal a chimney 600. The ceiling 440 of the gas path chamber 410 may be defined, in part, by the underside 1500 of the plancha 1000. The gas path chamber may further define an inlet 420 positioned at or near the outlet 330 of the stack chamber 310, and within the gas path chamber floor 450, and an outlet 430, which may be defined by the back end wall 480 of the gas path chamber 410, and positioned at or near the chimney 600. The inlet of the gas path chamber 410 may be in fluid communication with the stack chamber 310 at the outlet 330 of the stack chamber 330.

In some cases, the gas path is designed to aid in increasing the velocity of a gas traveling through the chamber. In many cases the floor 450 of the gas path chamber 410 may be sloped upward toward the plancha 1000 such that the floor 450 is higher (as measured from level ground) at the back end 480 than at the front end wall. In some cases, the slope of the gas path chamber may be greater than about 0.1°, 0.5°, 1.0°, 1.5°, 2.0°, 2.5°, 3.0°, 3.5°, 4.0°, 4.5°, 5.0°, or 5.5°, and/or less than about 6.0°, 5.5°, 5.0°, 4.5°, 4.0°, 3.5°, 3.0°, 2.5°, 2.0°, 1.0°, or 0.05°. Sloping of the gas path chamber may aid in enhancing heat transfer, and/or plancha upper surface temperature distribution. In many cases, sloping of the gas path chamber may aid in enhancing the velocity of combustion gas traveling through the stove. In embodiments wherein the gas path chamber is sloped, the height of the gas path chamber may vary, for example the height of the gas path, at or near the front end, is larger than at or near the back end. In these cases, the cross-sectional area of the gas path chamber may decrease at or near the back end of the gas path chamber.

In many cases, the outlet 430 of the gas path chamber may aid in directing gases into the chimney box chamber 510 and the chimney chamber 600. In some cases, the outlet 430 may be designed to maximize the amount of heat transferred to the plancha 1000. The outlet 430 may comprise a single structure within the back wall of the gas path chamber 410, or may comprise two or more outlet structures 430. The gas path chamber 410 may be designed to prevent or reduce clogging or fouling of the gas path chamber when certain fuels are used (for example fuels that, when combusted, produce large amounts of ash or soot). In some cases, clogging may be due to particulates released by the fuel, for example high resin woods.

The gas path may be designed to aid in directing heated gases to one or more positions in the underside of the plancha. In some embodiments, the inlet 420 of the gas path chamber is positioned at or near the front wall 480 of the gas path chamber 410. In many cases, the inlet 420 is positioned in the front half, third, or quarter of the plancha 1000. In many cases, the inlet 430 is not positioned at or near the front end wall 480 within the gas path chamber floor 450, such that there is a portion of the gas path chamber floor 450, proximal the front end wall 480. Positioning of the inlet may aid in distributing heat more evenly over the surface of the plancha.

In some cases, the gas path is designed to reduce thermal warping of the gas path chamber. In some cases, relief features in the gas path chamber, for example stamped features, may aid in directing gases and/or reducing thermal warping. In many cases the disclosed relief features may be defined by the floor of the gas path chamber. In some cases, relief features in the floor may aid in directing hot combustion gases toward the underside of the plancha, thereby enhancing plancha heating and heat distribution. In many cases, the gas path chamber is designed to accommodate thermal expansion.

The gas path chamber may be insulted to aid in preventing heat loss and/or enhance heat transfer to the underside of the plancha. The gas path chamber may include a seal structure 1750 that may contact the plancha 1000. The seal structure 1750 may aid in preventing the exit of heated gases at positions other than the outlet 430. In some embodiments, the seal 1750 is a fiberglass gasket, or rope. In many embodiments, the gasket 1750 may be designed to rest in a channel structure 1700. The channel structure 1700 may be a part of the chamber wall 460, 470, 480 or may be an extension of the wall 460, 470, 480. In some embodiments, the gasket channel may extend from the wall into the gas path chamber.

In some cases, a structure may be positioned below the gas path chamber to aid in heating one or more materials. In some cases, a fuel storage area may be positioned below the gas path chamber to aid in curing or drying fuel, such as wood. In other embodiments, a box or oven area may be positioned below the gas path chamber.

### Chimney Box

A chimney box 500 may be positioned at or near the rear end wall 470 of the gas path chamber 410. The chimney box chamber 500 may define an inlet 520, an outlet 530, a front wall 580, a back wall 570, a floor 550, a ceiling 540, and sides 560. The inlet 520 of the chimney box chamber 510 may be in fluid communication with the outlet 430 of the gas path chamber 410. The chimney box chamber 510 may define an ash collection box 495, which may be accessible by a door defined by the wall 560 of the chimney box chamber 500. In many cases, the door in the chimney box may be defined by one or both of the sides. The door may allow access into the chamber to aid in removal of ash that may collect in the ash box. In some cases, the door may include other structures that may aid in the ash collection, for example an ash box floor that may be designed to rest upon some or all of the chimney box floor 550. The chimney box may be insulted. In some embodiments, insulation may be placed in contact with the inner and/or outer surface of the chimney box, for example the floor, the back wall, the ceiling, and/or sides.

The chimney box may define an inner surface 504 in communication with heated gases from the combustion chamber 210, and an outer surface 505. In some cases, the outer surface 505 of the chimney box 500 may define a planar surface parallel to the plancha surface 1000. In many cases, the outer surface 505 of the chimney box 500, for example the outer surface of the ceiling 540 may be used to position and support a cooking vessel. In some cases, the outer surface 505 may be used to warm the cooking vessel and/or a substance within the cooking vessel. The outer surface 505 of the chimney box 500 may further include relief features that may be similar to the relief structures 290 of the combustion chamber 210 shown in FIG. 4. Relief features of the chimney box may aid in reinforcing the chimney box. In some cases, the relief features are stamped features. In some embodiments, the relief features may be logos.

The ceiling of the chimney box may define the chimney box outlet. The chimney box outlet 530 may be in fluid communication with a chimney chamber 610. The outlet 530 of the chimney box chamber 510 may be in fluid communication with the inlet 620 of the chimney chamber 610. In some cases, the outlet 530 of the chimney box chamber 510 and the inlet 620 of the chimney chamber 610 may define one or more couplers for connecting the chimney box 500 to the chimney 600. In some cases, the coupler may define a cone structure of varying diameters. The cone structure may aid in connecting to one or more chimneys of varying diameter.

### Chimney

The chimney 600 may define an inner surface 604 and an outer surface 605. The inner surface may define a chamber 610 having an inlet 620, an outlet 630, and walls 660. The inlet 620 of the chimney chamber 610 may be in fluid communication with the outlet 530 of the chimney box chamber 510. The outlet 630 of the chimney chamber 610 may allow gases to escape the stove 100. The interior surface 604 of the chimney may define the chimney chamber 610. The chimney 600 may be insulated. In some cases, the insulation may be in contact with the interior or exterior surface of the chimney. In some cases, the insulation may define a second exterior chimney surface, for example a double walled chimney wherein the interior surface of the first wall is in fluid contact with heated combustion gases, and the exterior surface of second wall is in fluid communication with the ambient environment surrounding the stove. The first and second wall may define a gap or chamber between the exterior surface of the first wall and the interior surface of the second wall. In some cases, an insulating material may be positioned in the gap or chamber defined by the first and second walls. In some cases the insulation may aid in maintaining the gas temperature in the chimney chamber to aid in the gas passing through the chimney. In some cases, insulation may aid in preventing the user from receiving a contact burn, in other cases, the chimney may further include a guard structure that may prevent contact with the exterior surface of the chimney.

In some cases, the chimney may define a damper that may aid in controlling the velocity of gases passing through the chimney. In some cases, the damper may be an automatic damper that may automatically adjust the position of the damper. In some cases, the automatic damper may monitor barometric pressure to adjust the damper position.

The chimney may define one or more outlet structures. In some cases, outlet structures may be positioned opposite the inlet, or at right angles to the inlet. In many cases, the chimney outlet structures may be designed to reduce or prevent back-draft through the stove. Back-draft may refer to air that enters the chimney outlet and travels toward the combustion chamber inlet.

### Assembly and Construction

The disclosed plancha-style stove may be constructed of metal alloys. In some cases, the alloy is a high temperature alloy that may aid in increasing the lifetime of the stove and/or helping aid in preventing heat loss. In some cases, high temperature specialty alloy may be used for elongated stove lifetime.

The disclosed plancha-style stoves may be designed for assembly from manufactured components, locally sourced components, or a mixture thereof. In some cases, the plancha-style stove may include components of local, natural materials, for example brick, mud, cement, clay, and rocks. In some cases, the plancha-style stoves may be constructed using tabs and/or rivets to aid in assembly.

### EXAMPLES

### Example 1

### Versions 1.0-1.6 Surface Thermographs

Various configurations of the disclosed plancha-style stove were constructed and tested as described below. V1.0 comprises a combustion chamber that is widened and the placement of the adjusted; V1.1 includes a tapered depth of the gas path chamber; V1.2 includes a centralized restriction added to the rear portion of gas path chamber; V1.3 includes insulation added to combustion chamber; V1.4 has insulation added to gas path and a deflector added and the rear widened; V1.5 comprises support ribs in the gas path chamber; and V1.6.

The versions described above were compared to a Justa-style plancha stove. The Justa design is widely available and was developed through a coordinated effort of various organizations. The body of the Justa stove is traditionally built with a variety of different materials, usually natural materials that are readily available, for example cement, clay, sand, brick, and adobe. The Justa can also be constructed of metal.

Briefly, in order to compare heating efficiency of the plancha surfaces, an equivalent amount of fuel was placed within the combustion chambers of the stoves and ignited. The fuel used was retail lumber (for example spruce, pine, or fir), which was fed into the combustion chamber at a rate of about 7.5 grams per minute for 60 minutes. The surface temperature of the stove was monitored for 60 minutes. After 60 minutes the fuel was weighed and the weight compared to the beginning weight to calculate fuel consumption rates and ensure similar fuel consumption had been achieved. Thermographs of the plancha surfaces were captured at the 60 minute point.

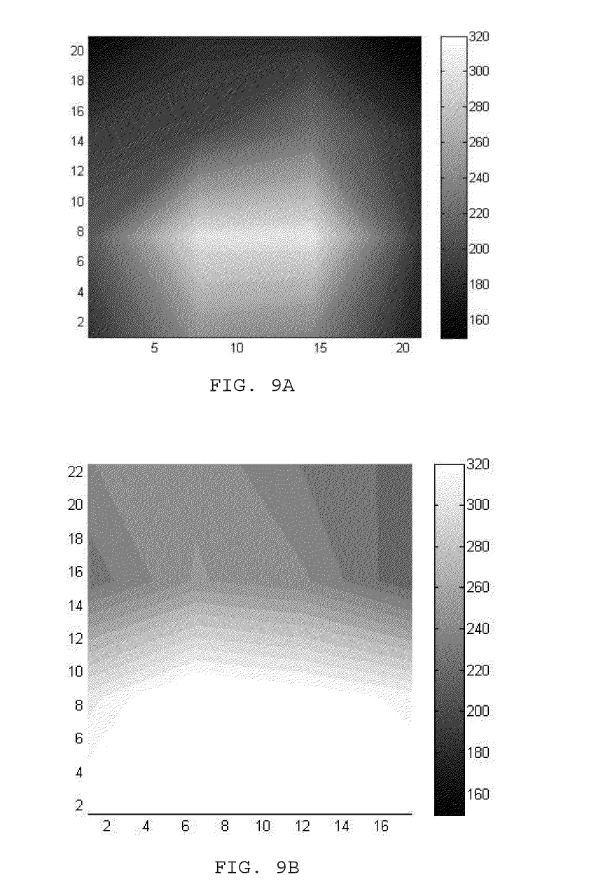

Results from the surface temperature analysis are presented at FIGS. 7A-7H and FIG. 9.

### Example 2

### Efficiency Analysis

The disclosed plancha-style stove was compared to a Justa-style stove, using a modified Water Boiling Test, in order to compare the efficiency of the stoves. Specifically, the WBT 4.1.2. was used (available at the website www.pciaonline.org/testing)

In some cases, this test may be referred to, in some cases, as the Emissions and Performance Test Protocol. Briefly.

The test consists of three phases that immediately follow each other. These are the cold-start high-power test, the hot start high-power test, and the simmer test. For the cold-start high-power test, the tester begins with the stove at room temperature and uses a pre-weighed bundle of fuel to boil (in some cases, 90° C.) a measured quantity of water in a standard pot. The boiled water is then replaced with a fresh pot of ambient-temperature water to perform the second phase of the test, the hot start high-power test. The hot-start high-power test is conducted after the first test while stove is still hot. Again, a pre-weighed bundle of fuel is used to boil a measured quantity of water in a standard pot. Repeating the test with a hot stove helps to identify differences in performance between a stove when it is cold and when it is hot. This may be particularly important for stoves with high thermal mass, since these stoves may be kept warm in practice. Finally, the simmer test provides the amount of fuel required to simmer a measured amount of water at just below boiling point (in some cases 90° C.) for 45 minutes. This step simulates the long cooking of legumes or pulses common throughout much of the world.

Results of the EPTP test are shown in FIG. 8. A thermograph of the planchas used is shown at FIG. 9.

All references disclosed herein, whether patent or non-patent, are hereby incorporated by reference as if each was included at its citation, in its entirety.

Although the present disclosure has been described with a certain degree of particularity, it is understood the disclosure has been made by way of example, and changes in detail or structure may be made without departing from the spirit of the disclosure as defined in the appended claims.

We claim:

1. A stove comprising:
a combustion chamber comprising an inlet,
a stack chamber comprising an inlet and an outlet;
a gas path chamber, comprising a ceiling and a floor, wherein the ceiling is defined by a removable plancha cooking surface having a substantially planar upper surface and a lower surface;
a chimney box; and
a chimney.

2. The stove of claim 1, wherein the stack chamber defines a cross-sectional area that is larger than the cross-sectional area of the inlet to the combustion chamber.

3. The stove of claim 1, wherein the stack chamber is wider at or near the outlet than near the inlet.

4. The stove of claim 1, wherein the cross-sectional area of the stack chamber varies less than 10% between the inlet and the outlet.

5. The stove of claim 4, wherein the cross-sectional area of the stack chamber is the same at the inlet as at the outlet.

6. The stove of claim 1, wherein the floor of the gas path chamber is separated by a greater distance from the ceiling at the or near the gas path chamber inlet as compared to the gas path chamber outlet.

7. The stove of claim 1, wherein the plancha lower surface comprising a plurality of fins extending from the lower surface.

8. The stove of claim 7, wherein the fins extend from at or near a rear end toward the front end.

9. The stove of claim 8, wherein the fins are define a straight line running from at or near the rear end to the front end.

10. The stove of claim 7, where in the fins define a height measured from the lower surface to the tip of the fin, and wherein one or more of the fins has a height that varies from the rear end of the plancha to the front end.

11. The stove of claim 1, wherein the plancha comprises an alloy material selected from iron, steel, or aluminum.

12. The stove of claim 11, wherein the plancha is cast iron.

13. The stove of claim 11, wherein the plancha is milled steel or aluminum.

14. The stove of claim 12, wherein plancha defines a thickness between the upper surface and the lower surface, and wherein the thickness of the plancha is smaller at the rear end as compared to the front end, and wherein a gasket positioned between the plancha and one or more sides of the gas path chamber.

15. The stove of claim 1, wherein the stove uses less than about 75% of the fuel required by a Justa stove to boil water.

16. A plancha comprising:
an upper surface;
a lower surface; and
a plurality of fin structures defined by the lower surface.

17. The plancha of claim 16, wherein the plancha is cast from iron.

18. The plancha of claim 17, further comprising a plurality of handles fixedly attached to the plancha, wherein at least one handle is housed in a recess defined in the plancha upper surface.

19. The plancha of claim 17, wherein the plancha defines a thickness that varies from a rear end to a front end of the plancha.

20. A plancha style stove comprising:
a combustion chamber having an inlet and an outlet, wherein the inlet is substantially rectangular;
a stack chamber having an inlet and an outlet, wherein the stack chamber is in fluid communication with the combustion chamber, wherein the inlet defines a cross-sectional area that is greater than a cross-sectional area of the combustion chamber inlet, and substantially equal to the cross-sectional area of the stack chamber outlet;
a gas path chamber comprising a floor a ceiling, and sides, the gas path chamber in fluid communication with the stack chamber, wherein the floor defines an inlet in fluid communication with the combustion chamber inlet, and an outlet, wherein the ceiling of the gas path chamber is defined by an underside of a plancha;
the plancha defining a upper side for cooking and the underside defining a plurality of fin structures for transferring and distributing heat from the gas path chamber and the upper surface of the plancha, wherein the plancha defines a rear end with a thickness that is less than a thickness of the front end;
a chimney box having an inlet and an outlet, the chimney box in fluid communication with the gas path chamber; and
a chimney comprising an inlet and an outlet, wherein the chimney is in fluid communication with the chimney box.
